(19) United States
(12) Patent Application Publication
(10) Pub. No.: US 2015/0339698 A1
(43) Pub. Date: Nov. 26, 2015

(54) A MEDIA SYSTEM WITH A SERVER AND DISTRIBUTED PLAYER DEVICES AT DIFFERENT GEOGRAPHICAL LOCATIONS

(71) Applicant: DIMENSION MEDIA IT LIMITED, Cork (IE)

(72) Inventors: Ian GALLAGHER, Cork (IE); Darragh ENRIGHT, Cork (IE); Gionata MINICHINO, Cork (IE); Eduardo MIRA JARILLO, Cork (IE)

(73) Assignee: DIMENSION MEDIA IT LIMITED, Cork (IE)

(21) Appl. No.: 14/435,648

(22) PCT Filed: Oct. 16, 2013
(86) PCT No.: PCT/EP2013/071652

§ 371 Date: Apr. 14, 2015

(30) Foreign Application Priority Data
Oct. 18, 2012 (IE) 2012/0464

(51) Int. Cl. G06Q 30/02; H04L 29/06

(52) U.S. Cl. CPC G06Q 30/0242; G06Q 30/0246; G06Q 30/0211; G06Q 30/0272; H04L 65/4069

(57) ABSTRACT

A media system (100) has a server (104) for receiving from users uploads of content and associated profile data. The profile data includes desired content playing geographical location, stait time, audience gender, and audience age group. The content is played by multiple player devices (104) at geographically spread locations. Each player device (101) has a display screen, a camera (102), a processor, and a communications interface for communicating with the server (104). The processor downloads content items from the server, plays the content items, and manages a queue of the content items by in real time capturing audience image data and determining for each audience member an impression including estimated age group and gender. It matches the impression data with the profile data for the content items in the queue in order to select a next content item for playing, the player devices upload impressions to the server after playing and the server (104) adds received impressions to a pool of impressions for an item of content.

### INTRODUCTION

### Field of the Invention

The invention relates to playing of content for applications such as advertising or other public information, particularly in public places.

### PRIOR ART DISCUSSION

The following documents describe systems which analyse viewers and/or select content according to conditions:
CN202917136, CN202373266, KR20120108306, US2008004950, US2002072952, EP1566788, EP1557810, JP2008226161, US2002/0072952, and US2009/0177528.

An object of the invention is to achieve an improved technical system for playing of content which is more relevant to a dynamically changing audience over multiple geographical locations, and with improved real time performance.

### SUMMARY OF THE INVENTION

According to the invention, there is provided a media system comprising:
a server for receiving from users uploads of content and associated profile data, said profile data including desired content playing geographical location, start time, audience gender, and audience age group,
a plurality of player devices at a plurality of geographical locations, each player device having a display screen, a camera a processor, and a communications interface for communicating with the server; wherein said processor is adapted to download a plurality of content items from the server, to play said content items, and to manage a queue of a plurality of said content items by:
   in real time capturing audience image data and determining for each audience member of a particular content item being played, by executing facial recognition software, an impression consisting of data about an audience member including estimated age group and gender,
   matching the impression data with the profile data for the content items in the queue,
   selecting a next content item for playing according to said matching,
wherein the processor is adapted to upload impressions to the server after playing a content item, and
wherein the server is adapted to add received impressions to a pool of impressions for an item of content.

In one embodiment, the player device processor is adapted to generate the impression in real time.

In one embodiment, each impression additionally includes: estimated mood, playing datestamp, playing timestamp, duration of the audience member viewing or listening, and whether one or more of a set of identifiable actions was performed by the audience member.

In one embodiment, the player device processor is adapted to include in an impression an indicator of an audience member action. In one embodiment, the action includes a smartphone of an audience member receiving or capturing data from the player device. In one embodiment, the action includes scanning a code such as a barcode or a QR code displayed in the content. In one embodiment, the action includes a transaction using a smartphone accessing a web site. In one embodiment, the action includes a Near Frequency Communication (NFC) transaction.

In one embodiment, the player devices are adapted to issue in an action a coupon to a phone of an audience member, and the server is adapted to perform operations to redeem the coupon. Preferably, the player devices are adapted to communicate with the server to notify it of which audience member has received a coupon, as determined by an interaction with the player device, and the server is adapted to track progress of the coupon.

In one embodiment, the player device processor is adapted to include in an impression a flag indicating whether estimated audience member data matches a target parameter in the profile data for the content item. In one embodiment, the player device processor is adapted to save said flag in the impression in exclusion to the original estimate data. Preferably, the player device processor is adapted to save in an impression a flag indicating if an estimated audience age group matches a target age group in the profile data for the associated content item.

In one embodiment, the server is adapted to download content items to the player devices only if the player devices match parameters specified in the profile data. Preferably, said parameters include geographical location.

In one embodiment, the player device processor is adapted to manage the queue according to whether a content item has given rise to a target number of impressions specified in its profile data.

In one embodiment, the player device processor is adapted to manage the queue according to whether a start time or an end time of the content item as specified in the profile data has been reached.

In one embodiment, the player device processor is adapted to manage the queue according to whether a campaign including the content has been stopped.

In one embodiment, the player device processor is adapted to manage the queue according to weights or bias applied to content items, based on their profile data. Preferably, the player device processor is adapted to prioritize playing of a content item with a narrower demographic target audience specified in the profile data.

In one embodiment, the player device processor is adapted to manage the queue by dynamically determining a value for a passes parameter which is a minimum number of content item plays during which a particular content item is out of the queue. In one embodiment, the passes parameter value is calculated as an integer number closest to the number of content items divided by a factor.

In one embodiment, the player device processor is adapted to execute a plurality of threads in parallel.

In one embodiment, the threads include:
a download thread which is called periodically and requests from the server any new content for potential playing and its associated profile data, and saves said content in the queue;
a play thread for managing the content item queue, selecting the content item to play, and playing said content item;
an impressions thread which gathers the impression data for currently-playing content, in which every time an impression is recorded it is saved in a database with other impressions for the content item;
a post-play thread which is called every time an item of content is finished playing and saves the impression data captured during the content item playing,
a worker thread for uploading the impression data on a periodic basis, at a frequency of less than every 100 seconds, preferably less than 50 seconds, and most preferably less than 5 seconds.

In one embodiment, there is a thread for downloading from the server current playing parameters for content items, operation of said thread being triggered by playing of a pre-set number of content items from the queue. Preferably, said parameters include modifications to profile data including a value for target number of impressions for a content item.

In one embodiment, at least some of the display device screen, a video camera, and digital processors are integrated in a housing. Preferably, the system comprises a plurality of cameras, mounted at different sides of the screen. In one embodiment, at least one camera has an adjustable viewing position.

In one embodiment, at least some player devices further comprise at least one speaker. In one embodiment, the speaker is located below the screen.

In one embodiment, the server is adapted to maintain a count of total number of impressions for each content item and dynamically chooses content to subsequently download accordingly. In one embodiment, the server is adapted to set a target number of impressions for a content item by adjusting a user-provided number according to estimated error in estimating impression data by said facial recognition engine. In one embodiment, the error is in identification of gender and/or age group.

In another aspect, the invention provides a computer program product comprising software code adapted to perform the server and player device steps of a system as defined above in any embodiment when executing on a digital processor.

### DETAILED DESCRIPTION OF THE INVENTION

### Brief Description of the Drawings

The invention will be more clearly understood from the following description of some embodiments thereof, given by way of example only with reference to the accompanying drawings in which:—

FIG. 1 is a combined block and flow diagram illustrating a media system of the invention and its operation;

FIG. 2(a) is a flow diagram illustrating operation of the system in more detail, and FIG. 2(b) is an entity relationship diagram;

FIG. 3 shows front, side, and plan views of a media system of the invention, FIG. 4 shows internal parts of the system, and FIG. 5 is an exploded view; and

FIGS. 6 and 7 are diagrams illustrating camera positions and adjustments.

### DESCRIPTION OF THE EMBODIMENTS

A media system 100 has a server 104 for receiving from users uploads of content and associated profile data. The profile data includes desired content playing geographical location, start time, audience gender, and audience age group. The content is played by multiple player devices 101 at geographically spread locations. Each player device 101 has a display screen, a camera 102, a processor, and a communications interface for communicating with the server 104. The processor downloads content items from the server, plays the content items, and manages a queue of the content items by in real time capturing audience image data and determining for each audience member an impression including estimated age group and gender. It matches the impression data with the profile data for the content items in the queue in order to select a next content item for playing, the player devices upload impressions to the server after playing and the server 104 adds received impressions to a pool of impressions for an item of content.

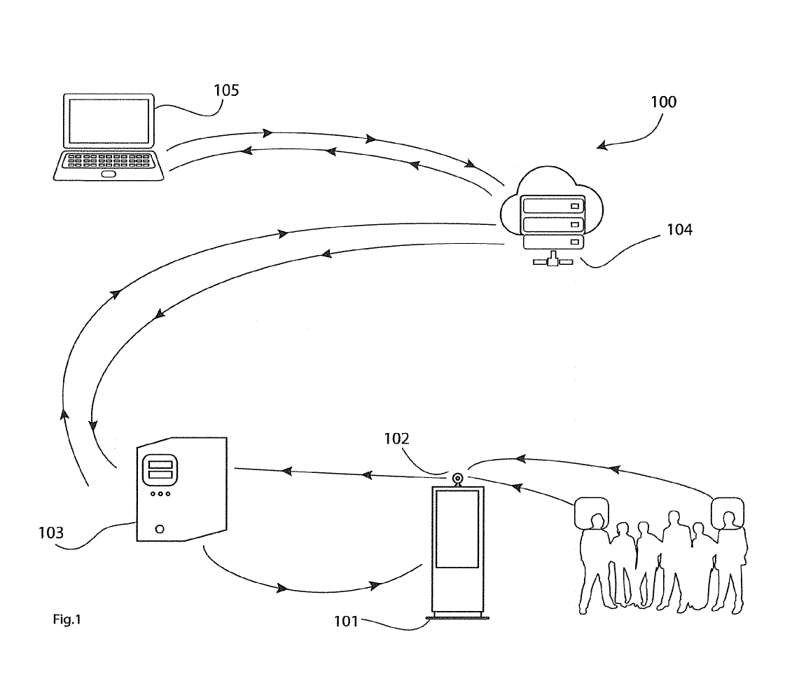

In more detail, and referring to FIG. 1 a media system 100 comprises a display 101 connected to a camera 102 and a CPU 103. The CPU 103 is linked via a wide area network with a server 104, in turn accessed by a user computer 105.

The specifications of the items are as follows:

Camera 102

| | |
|---|---|
| Connection Type | USB |
| Lighting Requirements | Calibrated for the intended location such as |
| | brightly lit indoor location or outdoors with |
| | variable ambient illumination. |
| Face Detection | Up to about 7 m at a camera resolution of |
| | 640 × 480 or up to about 20 m at camera |
| | resolution of 1280 × 960 |

CPU 103 and Display 101

| | |
|---|---|
| System | Intel ® Core ™2 Duo 2.0 GHz or faster |
| | (2.4 GHz is preferred) |
| OS | Windows* XP*, Windows Vista*, or Windows 7 |
| Memory | 1 GB for Windows XP, 2 GB for Windows Vista |
| | or Windows 7 |
| Minimum screen size | 47 cm display |

Server 104

| | |
|---|---|
| System | AMD Opteron ™ Processor6272 (2.1 GHz) |
| | 1 dedicated CPUcore. |
| OS | Linux ™ |
| Memory | 2 GB RAM |
| Hard Drive Space | 40 Gb usable space, and 400 Gbdata transfer |

The display device 101 executes player software to play content, mainly movies, in a determined order, in either portrait or landscape orientations. The camera 102 has on-board circuits for facial recognition and is connected to the display device 101, which is in turn connected to the CPU 103. It gathers facial recognition data and sends it to the CPU 103 for processing to provide impression data as part of feedback data concerning persons viewing the played content. A wired or a wireless Internet connection is provided in the CPU 103 in order to communicate with the server 104. The server 104 may be one or multiple physical servers grouped logically, or deployed as a cloud service.

An “impression” is data generated from a single view from an individual for an item of content. It includes in one embodiment:
estimated gender,
estimated age group,
mood (happy, angry, sad, surprised)
datestamp,
timestamp,
duration of the view,
any particular action performed by the viewer such a scanning a displayed code, and
link activation by the person using a smartphone.

The server 104 hosts media content assets and data and communicates with the player software on the display 101 and the CPU 103. The server 104 executes an API that communicates with the player software.

The CPU 103 performs image capture and facial recognition. It decides on content to play, and this is typically stored locally, but may be downloaded from the server 104 either in real time or preferably in advance so that there is minimal impact on real time performance. The action of selecting and commencing playing of content takes a time in the order of only milliseconds.

While the content is playing the CPU 103 analyses the captured video of the persons viewing the display. It determines the following as part of the feedback data:
number of people viewing, and
for each such person, it generates an “impression” as set out above.

The action may be an activity such as the person capturing, using her smartphone, a displayed code such as a QR code or a bar code, or capturing data using the NFC (Near Field Communication) protocol.

The CPU 103 on-the-fly determines the next content to play according to the current impressions.

At timed intervals, the CPU 103 analyses the impressions and generates requests for the server 104 for additional content. The server 104 correlates the uploaded impression data with profile data uploaded by clients using their computers or smartphones 105, and then downloads selected content. Hence there is automatic correlation and download of appropriate media content for playing.

The following describes the process implemented in one embodiment.
(1) A client user uploads content with a Movie File to the server 104 using his computer 105. The user also adds associated profile data to the content: gender, age range, start date, stop date, start time, stop time, total impressions, link (QR code, Barcode or NFC code), and geographical location category. The total impressions parameter is the total number of viewers required for the content. An impression will be generated by the CPU for each viewer. The profile data may be broad (e.g. wide age range and/or both male and female), or more specific. The scope of the profile is selected by the client user who uploads it.
(2) The central server 104 organizes this information. It subsequently allows the player software installed in the local CPU 103 in the location category selected to access the content and the associated profile data, via an API. More than one CPU 103 with the installed player software can be reached at the same time. There is a one-to-many relationship between the host server 104 and display devices 101.
(3) In each CPU 103, the player software (“Dimension Player Software”, DPS) requests content through the API. The DPS then does the following:
   (a) Downloads the content.
   (b) Analyses the associated profile data in order to determine the criteria by which the content will be added to a local content queue and played.
   (c) Adds the content to the playing queue when the Start Date and Start Time is met.
   (d) Removes the content from the playing queue when either of the following two cases are met:
      i. The stop date and stop time is met.
      ii. The total impressions number is reached.
(4) Plays and displays the content by following this process:
   P1 The player reaches the last time period (configurable) of a current content item.
   P2 The player preemptively selects the next movie to play by finding the content item with more matches in the age range and gender profile data among the last audience (set of impressions). If there are more than one content item available to play with the same number of matches then the player will select the one that has more specificity (narrower demographic range). By biasing the content selection towards the narrower demographics the player ensures that there is not an unacceptably high frequency of playing a content item with broad profile data.
   P3 If the audience is equal to zero, the player will just play the next content item in the queue.
   P4 A movie cannot be played twice or more times in a row. This is controlled by a “passes number”. This number is usually 3 or half the number of total movies in the current playlist.
   P5 Level of specificity or weight is a ranking number that indicates how narrow the target audience of a movie is calculated. For example, a movie targeting males and females of the ages between 25 and 65 will have a lower weight than a movie targeting only females of ages between 25 and 35.
(5) For each person in the audience that is captured, the facial recognition software in the camera records it as an impression and sends it to the CPU 103. The software engine for generating the gender and age group impression data is a Shore™ engine. SHORE™ is a platform-independent, configurable facial detection and facial recognition software library developed by FRAUNHOFER IIS™. The library performs real-time image analysis including: recognition and tracking of faces/objects and categorization of gender, mood and age. The library is integrated into each CUP 104, via a choice of interfaces (C++, flat file, TCP/IP).
(6) The DPS requests from the SHORE™ all the impression data that are recorded while the content item was playing. The DPS then does the following as soon as the content stops playing:
   Associates the impressions with the content item that just played. Saves the data in the database and sends it to the server 104.
   Analyses the last set of impressions in order to determine which content item to play next in the queue.
(7) The server 104 receives the impression data from the DPS, and saves it in a database.
(8) The user is able to access the impressions metrics and analytics of the content played, stop the playing of the content as well as create new content items with their respective associated profile data in order to start the process again.

In some embodiments, the device 101 has an NFC peripheral which allows viewers to “swipe” their phone and obtain coupons for the campaigns currently being played on the devices. When the coupons are issued to the phone, the Web-application on the server 104 is also notified of what user obtained which coupons. This will allow the system 100 to track the information about a purchase and avoid issuing the same coupon twice to the same account. These coupons can be then converted to vouchers by the viewer in shops that adhere to the scheme. The process of redeeming will vary from retailer to retailer. NFC may be employed at that end of the process as well. Alternatively, interfaces such as QR codes, bar codes or a web interface may be used to mark a coupon/voucher as redeemed.

The following sets out the content item (Movie File or static image) selection algorithm in more detail.

A content item has the following properties in its profile data:

minAge, maxAge, gender, plays, weight (specificity), passesLeft, totalMatches, totalAudience, suspended (bool), budget, budgetSpent, basecost, targetcost, expired and down the line.

A Person has properties gender and age.

The global value “Passes” is equal to floor (# of content items/2). For example, if the playlist contains 25 items, then the number of passes is equal to the “floor” (meaning, the integer part of a number with decimals) of 25/2. In other words 25/2=12.5. Discarding the decimals, the Passes will be 12. This value represents the number of plays a campaign is out of the queue before it can be played again. Uploading of a content item for playing at the multiple devices 101 is referred to as a “Campaign”.

### 1. [ITERATE]

for each Person p in an Audience:
   a for each Campaign c that is not suspended and with passesLeft equal to 0:
      if c.gender is ‘B’ (both) or c.gender equals p.gender then:
      if p.age is in range (c.minAge, c.maxAge) then:
      add 1 to c.matches

### 2 [SELECT CAMPAIGN TO PLAY]

At the end of the iteration, extract campaign(s) with the highest number of matches.

If two or more Campaigns have the same number of matches then play content item for the Campaign with the higher weight.

If two or more Campaigns have equal matches and weight, play the one with the least plays. After this play the Campaign that has the oldest last play.

Typically the time taken to execute the above algorithm is of the order of milliseconds.

### 3 [PLAY AND UPDATE CAMPAIGN STATS]

When a Campaign is marked for playing:
add 1 to c.plays and Passes (global) to c.passesLeft
subtract 1 to passesLeft to all campaigns (except the one marked for playing), unless they are already at 0
add c.matches to totalMatches and currentAudienceSize (# of people detected when this operation is performed) to c.totalAudience (this will enable us to calculate the hit ratio of the advertisement)
add an amount to c.budgetSpent corresponding to the cost of the impressions recorded

If c.budgetSpent goes over budget, set c.suspended to true.

Importantly, the server 104 receives and manages the impression data on a per-content item basis. Thus for example it determines dynamically the current number of audience members for the content. It can set the desired number of impressions by taking into account a statistical error in gender or age group identification. For example, if a user sets a required number of viewers as 100,000, the server 200 may set a Total Impression parameter value of 110,000 to allow for a 10% potential error to ensure that the target number of viewers is actually reached.

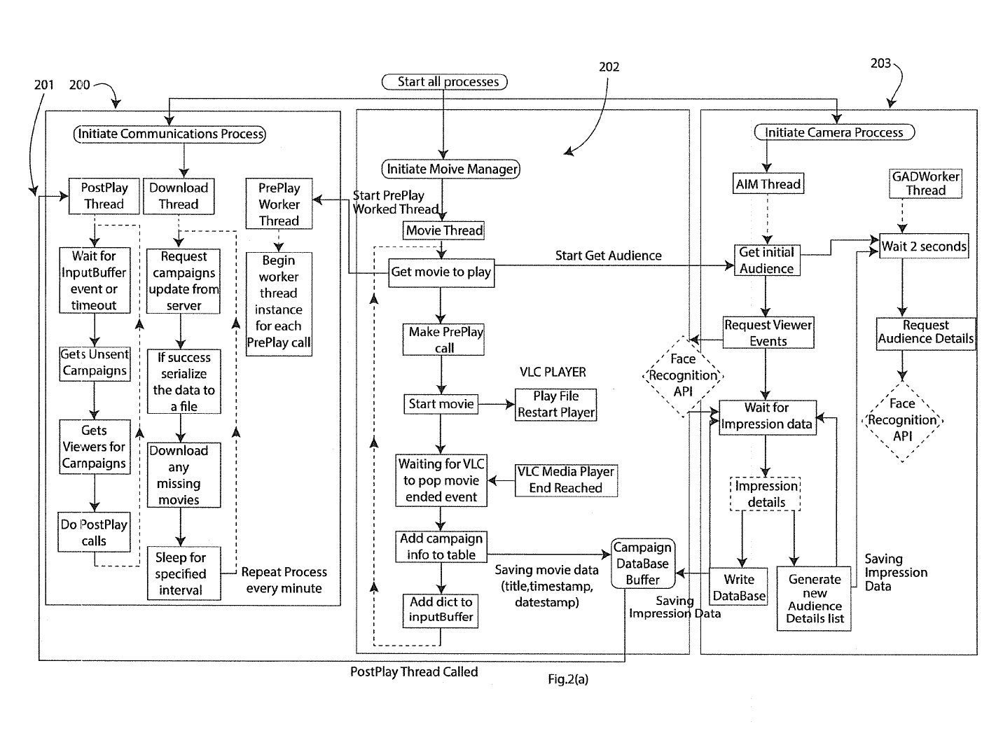

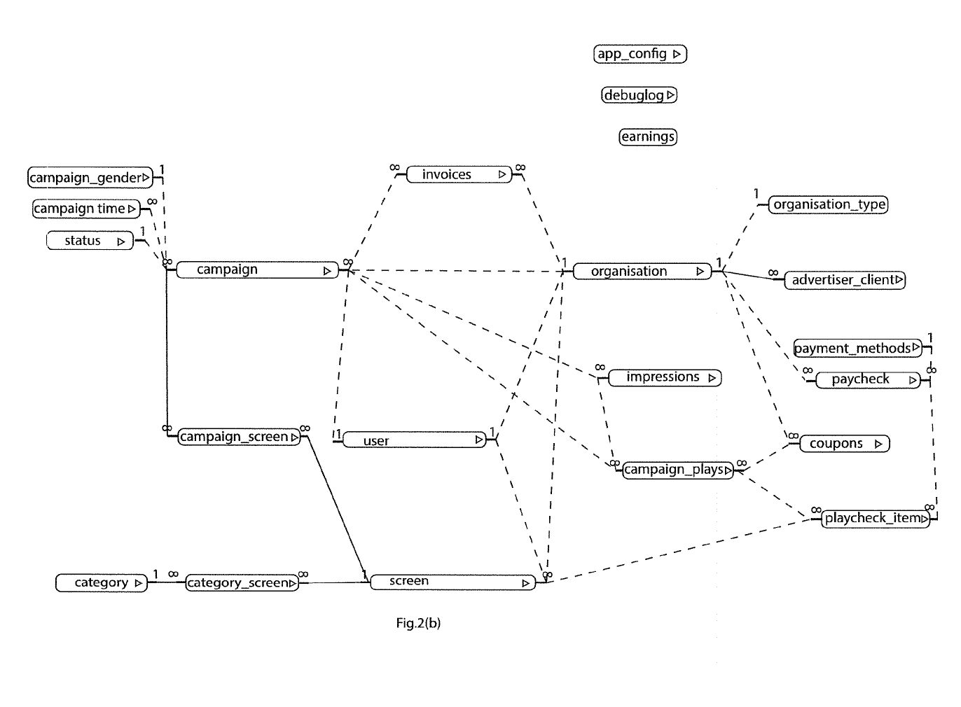

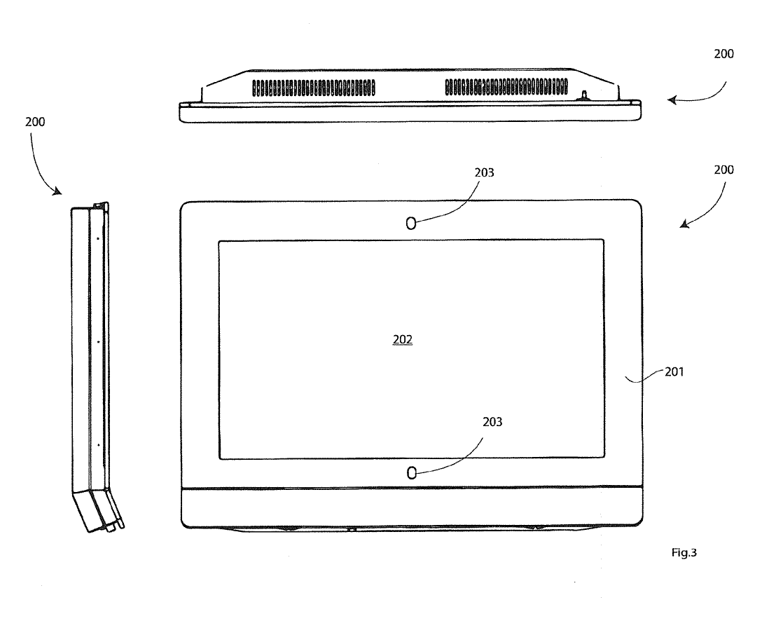

Referring to FIGS. 2(a) and 2(b) the left hand branch 201 is communications between the central server 104 and the CPU 103. The downloaded content is referred to in this example as a “campaign”. The step of matching viewers for campaigns comprises three different processes:
Download Thread: This process is called every minute and so is near real time. What it does is request from the server 104 any new content. In case that there is new content to download, it downloads the content and the data profile associated with it, saves it locally and adds it to the queue if the Start Date and Time is reached. A related thread may download from the server current playing parameters for content items, operation of said thread being triggered by playing of a pre-set number of content items from the queue. These parameters include modifications to profile data including a value for target number of impressions for a content item.
PrePlay Worker Thread: This process is necessary every time before a content item is played. This will check the following and determine if the movie will be kept or taken out of the playing queue:
a. If the movie has reached the budget set then the movie won't play.
b. If the End Date has been reached.
c. If the campaign has been stopped or cancelled from the server.
If any of the above is affirmative, the movie will be taken out of the playing queue.
Postplay Thread: This process is called every time a content item is finished playing. It sends to the server 104 the impressions captured during the content item playback. The server then will add the impressions collected to the pool of impressions set for that campaign by the user. The upload of impressions could alternatively be done at regular time intervals, such as hourly. A related worker thread uploads the impression data on a periodic basis, at a frequency of less than every 100 seconds, preferably less than 50 seconds, and most preferably less than 5 seconds.
AIM (impressions) thread which gathers the impression data for currently-playing content, in which every time an impression is recorded it is saved in a database with other impressions for the content item;

The control branch 202 is performed by the CPU 103 and the display 101, and the main process is the Movie Manager. This process controls the playback of the content item and is called at the same time as the next process 203. The first step of this process is the “Get Movie to Play” function. This function is the selector that checks which of the movies has to play according to the rules set out above. When the movie is finished playing the movie file, the “Get Movie to Play” function is called again. The “movie” may alternatively be a static image which is displayed for a pre-determined time, or indeed an audio clip with or without an image.

The right hand branch 203 is performed by the CPU 103 and the camera 102. It is this unit which generates the impression data and saves it. This branch has two main processes:
1. AIM Thread: This gathers all the impression data (Audience) from the SHORE™ API that is playing at the same time as the Movie Thread 202. Every time an impression is recorded, it gets saved in the database with the rest of the campaign data and eventually is uploaded once the file finished playing (PostPlay Thread 201).
2. GADWorker Thread: This process calls the SHORE™ API every 2 seconds to update the number of impressions as well as the data associated with them. The reason for this is that the more time a viewer (audience) is checking a screen, the more accurate the data is gathered. Therefore the impression data already recorded will be updated and upgraded every two seconds until the Movie Ended Event is called.

This description relates to a local CPU 103, however, more than one local CPU can be connected to the server and can be in different locations, playing movie files related to that location only.

FIG. 2(b) specifically shows the major entity relationships in the system. There is a one-to-many relationship between each campaign (content item) and impressions and campaign plays, and there may be a single organization with multiple users with many campaigns.

The following describes the structure of the database stored locally on the CPU 103 for playing of content and generating and storing the impressions.

### Campaign

### Description

A campaign record represents an uploaded advertisement movie or image and its related profile data such as:
Start and end dates between which the campaign is to be played on selected screens
Budget information specifying the campaign's maximum daily spend
Targeting criteria; i.e: gender, age range
Location filtering

Location filtering specifies the screens on which the campaign is to be restricted, by country, and optionally administrative zone and screen categories.

### Column Summary

| Name | Value | Note |
|---|---|---|
| advertiser_id | 3 | Foreign key |
| client_id | 5 | Foreign key |
| gender_id | 1 | Foreign key |
| status_id | 2 | Foreign key |
| age_min | 25 | |
| age_max | 45 | |
| artwork_landscape_name | /path/to/landscape.mp4 | |
| artwork_portrait_name | /path/to/portrait.mp4 | |
| budget_daily | 10000 | |
| cost_base | 20 | |
| cost_targeted | 45 | |
| cost_increment | 5 | |
| cost_specificity | 5 | |
| date_start | 2013-08-22 | |
| date_end | 2013-09-22 | |
| is_age_restricted | false | |
| is_approved | true | |

advertiser id
Unsigned integer.
Foreign key reference to the related advertiser. An advertiser is an organisation that creates campaigns in the system on behalf of themselves or clients.
client id
Unsigned integer.
Foreign key reference to the related client.
gender_id
Unsigned integer.
Foreign key reference to the related gender reference table.

### Options:

Male
Female
Both
   status_id
   Unsigned integer.
   Foreign key reference to the related screen reference table. A campaign can be in a number of states.

### Options:

Inactive
Active
Cancelled
Completed
Paused
   age_min
   Unsigned integer.
   Minimum age of targeted age range.
   age_max
   Unsigned integer.
   Maximum age of targeted age range.
   artwork_landscape_name

### String

Artwork (movie/image) filepath.
artwork_portrait_name

### String

Artwork (movie/image) filepath.
budget_daily
Unsigned integer
Daily maximum budget of campaign play costs for the current campaign. Typically representing value in cents.
cost base
Unsigned integer
Base impression cost for non-targeted views per person, defined in the system at campaign creation time. Typically representing value in cents.
cost_targeted
Unsigned integer
Targeted impression cost for targeted views per person, defined in the system at campaign creation time (base view), and increment, based on the specificity of selected targeting criteria. Typically representing value in cents.
cost_increment
Unsigned integer
Increment value for a single step of specificity defined in the system at campaign creation time. Typically representing value in cents.
cost_specificity
Unsigned integer
Units of specificity defined by selected targeting criteria.
date_start
ISO8601 datetime
Preferred start date of campaign, subject to moderation/approval.
date_end
ISO8601 datetime
Preferred end date of campaign.
is_age_restricted

### Boolean

Over-18 flag for campaign content.
is_approved

### Boolean

Moderation approval flag.

### Screen

### Description

A Screen is a device 101 installed at a location, such as a waiting room, shopping mall or other location where members of the public may interact. It is a software/hardware unit (DSOFT) containing a display, camera and software that controls the screen, collects facial recognition data and interacts with the system's web API. A screen record represents this physical device, from which a campaign can be served, and impression data can be gathered. A screen is optionally tagged with relevant categories based on its location and/or deployment; eg.: Waiting Room, Shopping Mall, Airport, Private Network.

### Column Summary

| Name | Value | Notes |
|---|---|---|
| publisher_id | 6 | Foreign key |
| title | Cork Airport Departure | |
| | Lounge | |
| accessed_at | 2013-08-22 15:41:39 | |
| street_number | null | |
| route | Kinsale Road | |
| locality | null | |
| administrative_area_level_1 | Cork | |
| administrative_area_level_2 | Cork | |
| country | Ireland | |
| postal_code | null | |
| latitude | 51.8449269 | |
| longitude | −8.4927917 | |
| Time zone | Europe/Dublin | |
| orientation | Landscape | |
| resolution | 1920 × 1080 | |
| screen_size | 21 inches | |
| username | username | |
| password | ******** | |

publisher_id
Unsigned integer.
Foreign key reference to the related campaign coupon.
title

### String

A human readable title/description of the screen.
accessed_at
ISO8601 datetime
The last interaction between the screen and system's API.
street_number

### String

Address field. Defined by Google Maps™ API.
route

### String

Address field. Defined by Google Maps™ API.
locality

### String

Address field. Defined by Google Maps™ API.
administrative_area_level_{—}1

### String

Address field. Defined by Google Maps™ API.
administrative_area_level_{—}2

### String

Address field. Defined by Google Maps™ API.
country

### String

Address field. Defined by Google Maps™ API.
postal_code

### String

Address field. Defined by Google Maps™ API.
latitude

### String

The latitude of the device 101.
longitude

### String

The latitude of the device 101.
timezone

### String

The TZ identifier that represents the current time zone of the physical device; e.g: Europe/London.
orientation

### String

The aspect of the display of the physical device; e.g: landscape, portrait.
resolution

### String

The resolution of the display of the physical device; e.g: 1024×768
screen_size

### String

The screen size of the display of the physical device; e.g: 60 inches
username

### String

A unique username. Used by the screen to authenticate/authorise itself with the system's API.
password
A unique password Used by the screen to authenticate/authorise itself with the system's API.

### Campaign Play

### Description

A campaign_play record represents a single instance where a campaign is played on a specific screen. The table's columns include datetime information for the play itself, aggregated data based on the individual impressions of that instance, plus foreign key references to related records, including campaign, coupon and screen.

### Column Summary

| Name | Value | Notes |
|---|---|---|
| screen_id | 2 | Foreign key |
| campaign_id | 1 | Foreign key |
| coupon_id | 2 | Foreign key |
| play_start | 2013-08-23 17:01:02 | |
| play_end | 2013-08-23 17:01:12 | |
| views_base | 4 | |
| views_target | 2 | |
| views_total | 6 | views_base + views_target |
| cost | 170 | value in units; e.g: cents |

screen_id
Unsigned integer.
Foreign key reference to the related screen.
campaign_id
Unsigned integer.
Foreign key reference to the related campaign.
coupon_id
Unsigned integer
Foreign key reference to the related coupon.
play_start
ISO8601 datetime
The start of the current campaign_play.
play_end
ISO8601 datetime
The end of the current campaign_play.
views_base
Unsigned integer
The sum of impressions for the current campaign_play that did not match the targeting criteria for the campaign.
views_target
Unsigned integer
The sum of impressions for the current campaign_play that did match the targeting criteria for the campaign.
views_total
Unsigned integer
The sum of impressions total for the current campaign_play.
cost
Unsigned integer
The total cost of the current campaign_play.

### Impression

### Description

An impression data record (“impression”) represents an individual view of a campaign_play. This record contains specific estimated data about the individual audience member, and is used to provide valuable metrics to advertisers and clients, in the form of statistics and graphable data.

It is the section that is of most interest from the point of view of mining for insights per campaign over time, by location, gender, age group, interaction duration and so on.

Impression data is communicated from a physical screen to the system's API.

### Column Summary

| Name | Value | Notes |
|---|---|---|
| \campaign_play_id | 3 | Foreign key |
| age | 20 | |
| detection_start | 2 | seconds |
| detection_end | 7 | seconds |
| dwell_time | 5 | seconds |
| gender | m | |
| is_target_age | −1 | under age |
| | | target |
| is_target_gender | true | |
| is_target | false | |
| is_coupon_recipient | true | |
| is_coupon_redeemed | true | |
| coupon_redeemed_datetime | 2013-08-23 18:32:01 | |
| coupon_redeemed_geolocation | lat, lng | |
| coupon_redeemed_address | 3 Voctoria Road, Cork, | |
| | Ireland | |

campaign_play_id
Unsigned integer
Foreign key reference to the related campaign_play.
age
Unsigned integer
The age of the viewer, determined by DSOFT.
detection_start
Unsigned integer
The number of seconds the viewer started interacting with the campaign_play.
detection_end
Unsigned integer
The number of seconds the viewer stopped interacting with the campaign_play.
dwell_time
Unsigned integer
The total number of seconds the viewer interacted with the campaign_play.
gender

### String

The gender of the viewer, determined by DSOFT.
is_target_age
Signed integer
A flag indicating if the viewer was within the campaign record's specified targeted age.

### Options:

Under the targeted age range (−1)
Within the targeted age range (0)
Over the targeted age range (1)
   is_target_gender

### Boolean

A flag indicating if the viewer was within the campaign record's specified targeted gender. By saving such flags the system effectively performs data compression, hence improving system performance.
is_target

### Boolean

A flag indicating if all target criteria were matched, defining the interaction as a targeted impression.
is_coupon_recipient

### Boolean

A flag indicating if the viewer swiped to receive a coupon offer related to the current campaign_play.
is_coupon_redeemed

### Boolean

A flag indicating if the viewer redeemed the received coupon offer.
coupon_redeemed_datetime

### ISO8601 Datetime

Datetime of redeemed coupon offer.
coupon_redeemed_geolocation

### String

Geolocation data for the redeemed coupon offer.
coupon_redeemed_address

### String

Address data for the redeemed coupon offer.

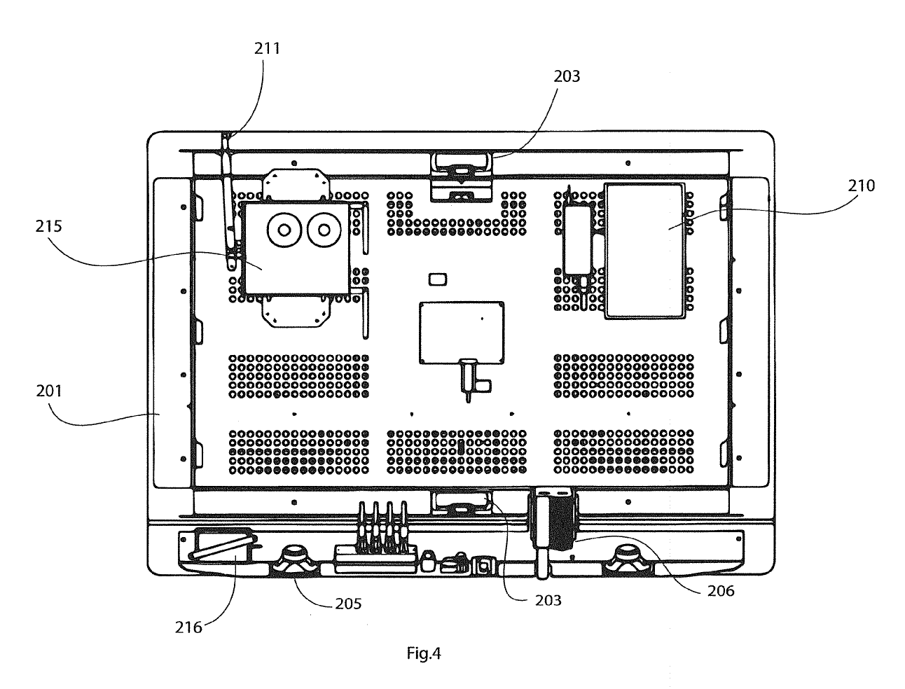

Referring to FIGS. 3 to 5 in some embodiments a device 101 may be in the form of a media system 200 which comprises, in hardware terms, a frame 201 supporting a display 202 and top and bottom cameras 203 centrally positioned. The system 200 also comprises a speaker 205 and speaker amplifier 206 located in the lower part of the system. There are power actuators 210 and 211, and a computer 215 for image processing and the other system control operations. The computer 215 is in this embodiment located within the frame, behind the screen 202. There is an NFC module 216.

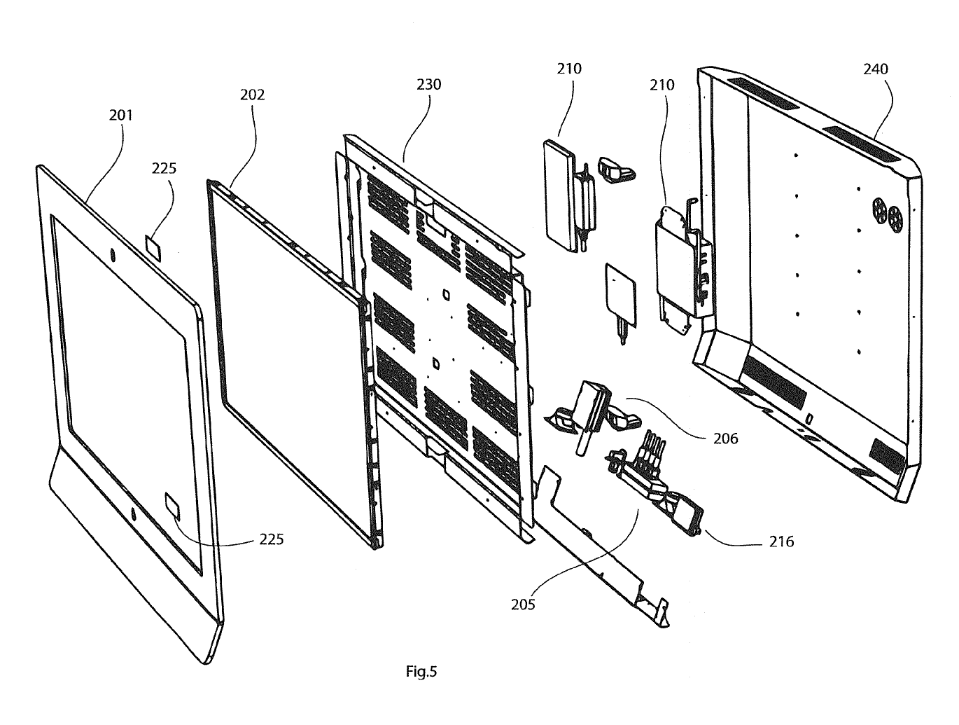

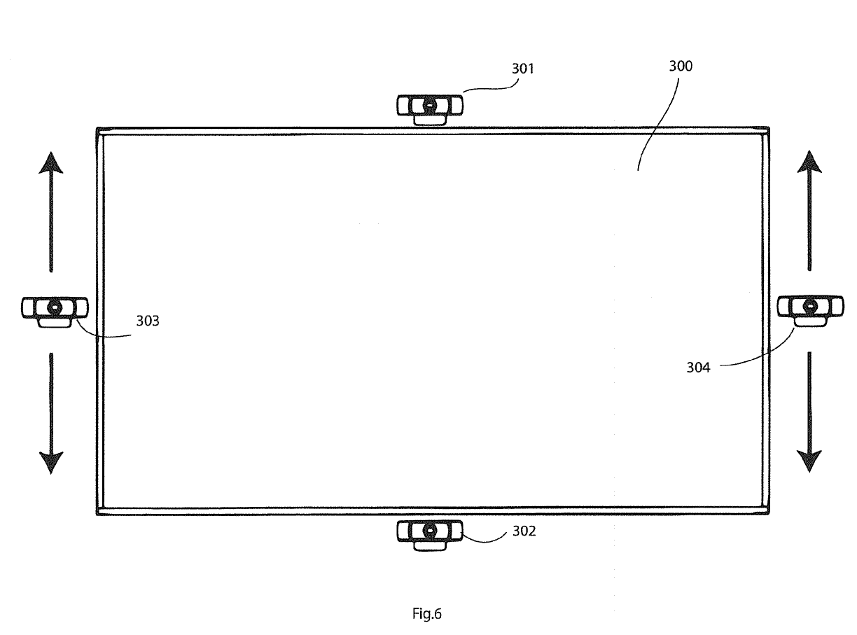

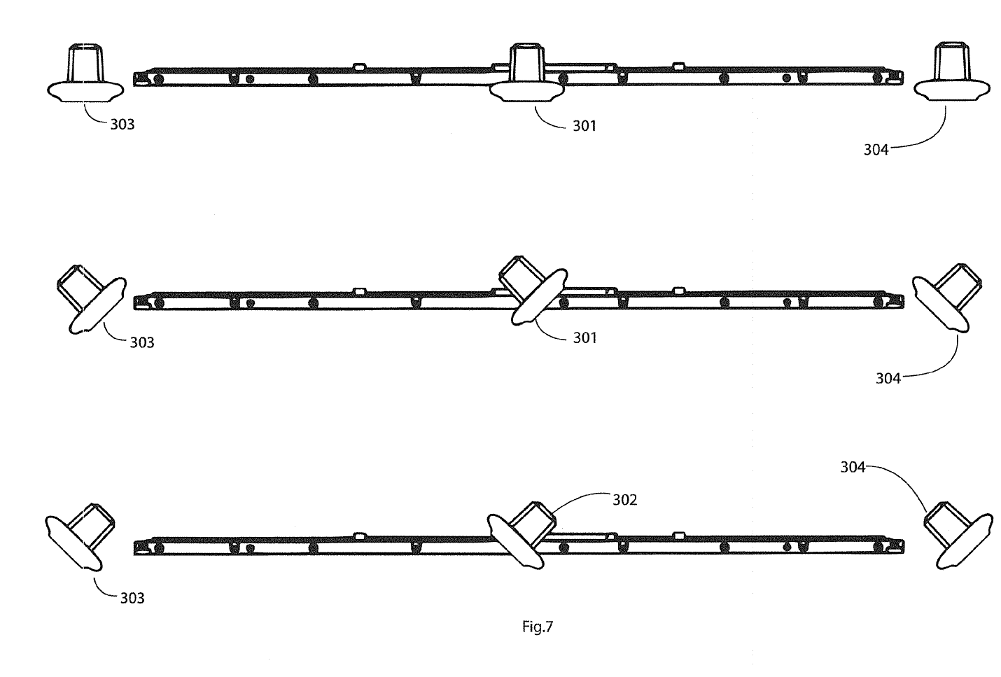

FIG. 6 shows diagrammatically possible camera positions, namely top and bottom central positions and two side cameras. The side cameras may be adjusted by any suitable adjustment mechanism to a desired vertical level. This allows adjustment to suit the system 200 mounting arrangement for optimum image capture. FIG. 7 shows that the cameras may, in another embodiment, by mounted to swivel in a vertical plane, again for optimum installation of the system.

In other embodiments the physical configuration may be:
Kiosks with various screen sizes and interface options (NFC, Credit Card, coin/bill acceptor etc. The cameras could be in any location relative to the screen as outlined in the drawings.
Billboard or a large screen as advertising panels only with the computer and other interfaces separated from the screen.
Custom arrangements designed for particular industry or market. An example is a waiting room for a doctor's surgery.

Provision of speakers is not essential and depends on the setting and advertising type. The computer 103 may be remote from the screen 101.

In other embodiments the screen may be a large poster style advertising panel. In this instance the advertising screen may have the camera located on its perimeter.

If separated from the main screen, the computer and technology could be housed in a mounted box nearby.

The screen orientation can be portrait or landscape and may be of any desired size depending on various factors such as the nature of the images to be displayed and the location of the system. The system could be retro-fitted to an existing screen, in which case the camera may be housed in a box that would be located close to the screen.

Different embodiments will have different ports such as LAN, Wireless, and USB ports.

It will be appreciated that the invention provides for optimum playing of content, both in terms of the audiences at various geographical locations and in terms of requirements of users who provide the content. It achieves a technical platform allowing much versatility in matching various criteria for optimum content playing. While the major embodiment described focuses on advertising, the invention is not limited to this. It may for example include other types of content according to the locations of the player devices. Indeed this is a benefit of the invention in which the system has player devices at different locations, and the server is programmed to download accordingly. For example a player device in a shopping centre may receive advertising content, whereas one located in an airport may play travel information (possible interspersed with advertising). A player device in a medical waiting room may play educational content tailored to the current audience. Also, it will be appreciated that the manner of generating the impression data leads to improved processor performance as there is effective data compression by saving only flags for some information items. The dynamic, real time, nature of communicating impressions to the server and the fact that the server is open to receiving uploads of not only content items and associated profile data, but also modifications to the profile data, help to achieve optimum system performance without unnecessary content communication.

The invention is not limited to the embodiments described but may be varied in construction and detail. For example the various processors which perform the operations of the system may be arranged differently with, for example, the server being local to the display device. Also, it is envisaged that at least some player devices may not have display screens, merely having audio speakers.

1-35. (canceled)

36. A media system comprising:
a server for receiving from users uploads of content and associated profile data, said profile data including desired content playing geographical location, start time, audience gender, and audience age group,
a plurality of player devices at a plurality of geographical locations, each player device having a display screen, a camera a processor, and a communications interface for communicating with the server; wherein said processor is configured to download a plurality of content items from the server, to play said content items, and to manage a queue of a plurality of said content items by:
in real time capturing audience image data and determining for each audience member of a particular content item being played, by executing facial recognition software, an impression consisting of data about an audience member including estimated age group and gender,
matching the impression data with the profile data for the content items in the queue,
selecting a next content item for playing according to said matching,
wherein the processor is configured to upload impressions to the server after playing a content item, and
wherein the server is configured to add received impressions to a pool of impressions for an item of content.

37. The media system as claimed in claim 36, wherein the player device processor is configured to generate the impression in real time.

38. The media system as claimed in claim 36, wherein each impression additionally includes: estimated mood, playing date stamp, playing timestamp, duration of the audience member viewing or listening, and whether one or more of a set of identifiable actions was performed by the audience member.

39. The media system as claimed in claim 36, wherein the player device processor is configured to include in an impression an indicator of an audience member action.

40. The media system as claimed in claim 36, wherein the player device processor is configured to include in an impression an indicator of an audience member action, and wherein the action includes a smartphone of an audience member receiving or capturing data from the player device.

41. The media system as claimed in claim 36, wherein the player device processor is configured to include in an impression an indicator of an audience member action, and wherein the action includes scanning a code such as a barcode or a QR code displayed in the content.

42. The media system as claimed in claim 36, wherein the player device processor is configured to include in an impression an indicator of an audience member action, and wherein the action includes a transaction using a smartphone accessing a web site.

43. The media system as claimed in claim 36, wherein the player device processor is configured to include in an impression an indicator of an audience member action, and wherein the action includes a Near Frequency Communication (NFC) trans action.

44. The media system as claimed in claim 36, wherein the player devices are configured to issue in an action a coupon to a phone of an audience member, and the server is configured to perform operations to redeem the coupon.

45. The media system as claimed in claim 36, wherein the player devices are configured to issue in an action a coupon to a phone of an audience member, and the server is configured to perform operations to redeem the coupon, and wherein the player devices are configured to communicate with the server to notify it of which audience member has received a coupon, as determined by an interaction with the player device, and the server is configured to track progress of the coupon.

46. The media system as claimed in claim 36, wherein the player device processor is configured to include in an impression a flag indicating whether estimated audience member data matches a target parameter in the profile data for the content item, and wherein the player device processor is configured to save said flag in the impression in exclusion to the original estimate data, and wherein the player device processor is configured to save in an impression a flag indicating if an estimated audience age group matches a target age group in the profile data for the associated content item.

47. The media system as claimed in claim 36, wherein the server is configured to download content items to the player devices only if the player devices match parameters specified in the profile data, and wherein said parameters include geographical location.

48. The media system as claimed in claim 36, wherein the player device processor is configured to manage the queue according to whether a content item has given rise to a target number of impressions specified in its profile data.

49. The media system as claimed in claim 36, wherein the player device processor is configured to manage the queue according to whether a start time or an end time of the content item as specified in the profile data has been reached.

50. The media system as claimed in claim 36, wherein the player device processor is configured to manage the queue according to whether a campaign including the content has been stopped.

51. The media system as claimed in claim 36, wherein the player device processor is configured to manage the queue according to weights or bias applied to content items, based on their profile data, and wherein the player device processor is configured to prioritize playing of a content item with a narrower demographic target audience specified in the profile data.

52. The media system as claimed in claim 36, wherein the player device processor is configured to manage the queue by dynamically determining a value for a passes parameter which is a minimum number of content item plays during which a particular content item is out of the queue, and wherein the passes parameter value is calculated as an integer number closest to the number of content items divided by a factor.

53. The media system as claimed in claim 36, wherein the player device processor is configured to execute a plurality of threads in parallel.

54. The media system as claimed in claim 36, wherein the player device processor is configured to execute a plurality of threads in parallel, and wherein the threads include:
a download thread which is called periodically and requests from the server any new content for potential playing and its associated profile data, and saves said content in the queue;
a play thread for managing the content item queue, selecting the content item to play, and playing said content item;
an impressions thread which gathers the impression data for currently-playing content, in which every time an impression is recorded it is saved in a database with other impressions for the content item;
a post-play thread which is called every time an item of content is finished playing and saves the impression data captured during the content item playing,
a worker thread for uploading the impression data on a periodic basis, at a frequency of less than every 100 seconds, preferably less than 50 seconds, and most preferably less than 5 seconds.

55. The media system as claimed in claim 36, wherein there is a thread for downloading from the server current playing parameters for content items, operation of said thread being triggered by playing of a pre-set number of content items from the queue, and wherein said parameters include modifications to profile data including a value for target number of impressions for a content item.

56. The media system as claimed in claim 36, wherein at least some of the display device screen, a video camera, and digital processors are integrated in a housing.

57. The media system as claimed in claim 36, wherein at least some of the display device screen, a video camera, and digital processors are integrated in a housing, and wherein the system comprises a plurality of cameras, mounted at different sides of the screen, and wherein at least one camera has an adjustable viewing position.

58. The media system as claimed in any claim 36, wherein at least some player devices further comprise at least one speaker, and wherein the speaker is located below the screen.

59. The media system as claimed in claim 36, wherein the server is configured to maintain a count of total number of impressions for each content item and dynamically chooses content to subsequently download accordingly, and wherein the server is configured to set a target number of impressions for a content item by adjusting a user-provided number according to estimated error in estimating impression data by said facial recognition engine.

60. The media system as claimed in claim 36, wherein the server is configured to maintain a count of total number of impressions for each content item and dynamically chooses content to subsequently download accordingly, and wherein the server is configured to set a target number of impressions for a content item by adjusting a user-provided number according to estimated error in estimating impression data by said facial recognition engine, and wherein the error is in identification of gender and/or age group.

61. A computer program product comprising non-transitory software code configured to perform the server and player device steps of a system of any preceding claim when executing on a digital processor.
